(19) United States
(12) Patent Application Publication
(10) Pub. No.: US 2024/0419995 A1
(43) Pub. Date: Dec. 19, 2024

(54) DATASET EXPLORATION PIPELINE USING CONDITIONAL INDEPENDENCE GRAPHS AND NEURAL GRAPHICAL MODELS

(71) Applicant: Microsoft Technology Licensing, LLC, Redmond, WA (US)

(72) Inventors: Urszula Stefania CHAJEWSKA, Camano Island, WA (US); Harsh SHRIVASTAVA, Redmond, WA (US)

(21) Appl. No.: 18/335,848

(22) Filed: Jun. 15, 2023

(51) Int. Cl. G06N 7/01

(52) U.S. Cl. CPC G06N 7/01

(57) ABSTRACT

The present disclosure relates to a dataset exploration system based on input data having a plurality of data samples having a plurality of features. In particular, the systems described herein generate preprocessed input data including one or more of performing data normalization, calculating covariance matrix, and assessing data quality of the preprocessed input data. The system further generates a domain structure from the preprocessed input data. The system further includes recovering a probabilistic graphical model (PGM) trained to discover the underlying joint distribution over the plurality of features based on the preprocessed input data and the domain structure. The learned PGM may be utilized to answer user queries by leveraging its probabilistic inference capabilities on the data and various different visual outputs may be presented via a display device.

### BACKGROUND

Recent years have seen a significant increase in the use of computing devices (e.g., mobile devices, personal computers, server devices) to create, store, analyze, and present data from various sources. Indeed, tools and applications for collecting, analyzing, and presenting data are becoming more and more common. These tools provide a variety of features for displaying data about various entities. In many cases, these tools attempt to generate and provide a display of a graph showing features of data and, more specifically relationships between various features within a collection of instances of data (e.g., samples of data).

As entities become more complex, however, conventional methods for collecting, analyzing, and presenting data have a number of limitations and drawbacks. For example, many conventional graph recovery approaches have difficulty in representing features of a variety of data types or having different types of value distributions. In addition, many conventional approaches for generating models and generating insights struggle with regard to datasets having relatively few samples or which have a large number of features associated therewith. Moreover, many techniques require a high level of user supervision in recovering an accurate representation of data.

These and other problems exist in recovering graphs and generating outputs for presenting insights associated with a variety of datasets.

### BRIEF DESCRIPTION OF THE DRAWINGS

FIG. 1 illustrates an example environment including a computing device having a dataset exploration system implemented thereon.

FIG. 2 illustrates an example workflow of a possible implementation of the data exploration system in accordance with one or more embodiments.

FIGS. 3A-3B illustrates an example output of summary statistics, according to at least one or more embodiments.

FIG. 3C illustrates an example output of a missingness analysis, according to one or more embodiments.

FIG. 4 illustrates an example of a domain structure graph, according to one or more embodiments.

FIG. 5A illustrates an example of an input data for a probabilistic graphical model manager, according to one or more embodiments.

FIG. 5B illustrates an example of a neural view of a neural graphical model (NGM), according to one or more embodiments.

FIGS. 6A-6C illustrate an example of dependency functions showing a pairwise relationships between a key variable and its top k most correlated neighbors identified in a graph, according to one or more embodiments.

FIG. 7 illustrates a series of acts for dataset exploration based on a collection of input data, according to one or more embodiments.

FIG. 8 illustrates certain components that may be included within a computer system.

### DETAILED DESCRIPTION

The present disclosure relates to systems, methods, and computer readable media for dataset exploration based on input data having a collection of samples and associated features. In particular, one or more embodiments described herein utilize probabilistic graphical models (PGMs) that can explore a dataset in multiple ways generating insights about the particular domain of information. The elements of dataset exploration system include dataset evaluation involving data summary statistics and missingness analysis, sparse graph recovery, creating a graph displaying a structure of the relevant information for the domain in the form of direct dependence between features (in some cases, these can be partial correlations). The elements further include drawing inferences using a PGM, which shows maximum a posteriori (MAP) values of all variables given specific values on evidence variables, and dependency graphs that show dependencies between pairs of variables. The features and functionality described herein facilitate generation of PGMs that provide accurate representations of data for a variety of domains and datasets and for collections of samples having different distributions of data. Moreover, the features and functionality described herein provide mechanisms that enable users to conveniently test ranges of key variables to draw inferences to efficiently and effectively gain insights on the dataset(s).

As an illustrative example, one or more embodiments described herein relate to methods and systems for generating and presenting insights on collections of data samples. The dataset exploration system may obtain input data including a plurality of data samples having a plurality of associated features. The dataset exploration system can additionally generate preprocessed input data, which may include performing data normalization, calculating a covariance matrix. Accessing data quality may include collecting summary statistics and performing missingness analysis. The dataset exploration system can additionally generate a domain structure from the preprocessed input data, the domain structure including representations of functional dependencies between the plurality of features of the plurality of data samples. The dataset exploration system may recover a probabilistic graphical model (PGM) trained to fit probabilistic density function over the plurality of features based on the preprocessed input data and (optionally) the domain structure. The dataset exploration system may further apply the PGM to observed or hypothetical evidence in a form of specific values assigned to a subset of features to determine inference results including conditional distribution and maximum a-posteriori (MAP) values for one or more variables of interest given evidence. The dataset exploration system may also generate a dependency function between two or more features represented in the domain structure based on the PGM. The dataset exploration system may also present an output via a display device based on one or more of the summary statistics, the missingness analysis, the domain structure, the PGM, the inference results, and/or the dependency function.

The present disclosure provides a number of practical applications that provide benefits and/or solve problems associated with dataset exploration. By way of example and not limitation, some of these benefits will be discussed in further detail below.

For example, by using probabilistic graphical models (PGMs) to explore a dataset, the dataset exploration system may create insights about the domain of information relevant to the dataset. In particular, using PGM it is possible to generate a domain structure in a form of direct and/or indirect dependencies between different features. This provides valuable information to the user in an easy-to-understand form regarding relationships between different features and to gain insight about the feature relationships to help with decision making. Furthermore, as PGM relies on probabilistic independence and conditional independence assumption between features, it is feasible in providing relevant information in domains having a large number of features.

In addition, in some embodiments, where the PGM being used is a neural graphical model (NGM), the NGM is able to learn a model capable of representing an unrestricted set of distributions over diverse data types. Indeed, while not all embodiments require the use of NGMs, these and other models described are applicable to a variety of dataset exploration approaches. As a result, where some conventional graphical modeling approaches (e.g., graphical lasso approaches) make certain simplifying assumptions in training a model to emulate the distribution of values within the data, in one or more implementations, a NGM can learn a sparse graphical model over the dataset regardless of distribution type and without limiting analysis of the input data to possibly over-simplifying assumptions. This provides more accurate inferences while facilitating satisfaction of certain sparsity constraints. Moreover, the features described herein may be applied to a variety of graphical recovery approaches, thus increasing the flexibility with which the methods and systems described herein can be applied in generating and presenting insights associated with a variety of datasets.

In addition, by using conditional independence graphs to learn partial correlations and/or dependences between features, the dataset exploration system is able to generate a sparse graph for features that have a variety of data types. Indeed, where many conventional graph recovery approaches are limited to specific types of data (e.g., either categorical or numerical), one or more embodiments of the dataset exploration system described herein learn partial correlations and/or dependences over distributions of features of a variety of data types. As will be discussed below, this approach allows the dataset exploration system to avoid certain assumptions that causes a resulting graph to have inaccurate connection information, significantly limiting the utility of insights that would otherwise be gained from the generated domain structure graph.

In addition to providing additional accuracy in the recovered graph, in one or more implementations described herein, the dataset exploration system reduces a number of edges/connections of the recovered graph to only include those connections that are determined to be directly connected. Two nodes (e.g., features) that do not have a connecting edge are determined to be conditionally independent of each other given all other nodes. This sparsity achieved in the recovered graph is maintained in an NGM providing rich and complex representation of the data that is provided as a result of applying a multi-layer neural network (e.g., a multi-layer perceptron) to the input data in a model in which the regression of features may be learned while enforcing a selected graph-based sparsity constraint.

The approaches described herein provide a flexible and scalable approach to recovering graphs and generating domain representation for a variety of data and for input data that has a robust number of features of similar or different types. As an example, in one or more implementations, the dataset exploration system utilizes a multi-layer perceptron and other neural networks that make use of structural sparsity constraints in learning a sparse graphical model over the data. In performing these operations, additional processing units, like graphical processing units (GPUs) can be applied to the matrix operations, providing availability to additional processing resources that are generally available on computing devices for carrying out calculations in determining the feature graph and ultimately generating a domain representation (e.g., a graph or full model).

Moreover, features of all elements of the dataset exploration system provide an approach that is unsupervised. Indeed, where some approaches require ground truth data to indicate known correlations between certain features of the input data, the graph recovery system utilizes carefully designed sparsity inducing regularization terms, which enables the recovery system to learn feature dependencies without involving supervision during the training process. Indeed, as will be discussed below, the input data may simply include a dataset with columns and rows and, by applying the graph recovery algorithm such as uGLAD to the data, the graph recovery system learns complex dependencies between features.

Moreover, features and functionality of the dataset exploration system provide a unique and flexible pipeline of operations and models that provide a rich representation of datasets for a variety of datatypes and for collections having a wide range of samples. The dataset exploration system provides a comprehensive set of insights regarding the input data without the need for the user to specify the type of analysis needed. In addition, a user-friendly mechanism allows a user to use a resulting model(s) to further query the system and obtain estimates the effect of different ranges of key values on other variables within the dataset. As will be discussed below, these inferences may be iteratively performed using the models in real-time and provide insights that would otherwise be unavailable but for the generation of the models and structures described herein.

As illustrated in the foregoing discussion, the present disclosure utilizes a variety of terms to describe features and advantages of one or more embodiments of a dataset exploration system. Additional detail will now be provided regarding the meaning of some of these terms.

As used herein, “input data” refers to a collection of input samples with associated features of the input samples. For example, input data may include a table including columns and rows in which the rows indicate a plurality of samples or subjects or other entities while each of the columns indicate “feature” of the corresponding samples. As used herein, a “feature” refers to a characteristic of a sample while “feature values” refer to values that are descriptive (quantitative or qualitative) or otherwise associated with a feature and a corresponding instance of an input sample.

As used herein, “summary statistics” refer to statistical measures that may be used to describe a collection of data, and may include metrics such as minimum, maximum, mean, median or mode, standard deviation, skewness, kurtosis and other statistical measure(s). Summary statistics may include information about value distributions represented for example as value histograms.

As used herein, “missingness analysis” describes an analysis of a pattern of missing data within a collection of samples. Missingness analysis may produce metrics such as missingness rate (fraction of missing values for a given feature in the dataset), missingness rate over time (for temporal data), missingness type: missing completely at random (MCAR), missing at random (MAR), missing not at random (MNAR) and missingness pattern for one feature being dependent on the values of other features. In MCAR the missingness is unrelated to the data, i.e. the probability of missing is the same for all samples. In MAR, the probability of missingness of a feature is determined from the observed values of the other features. In MNAR the probability of missingness is also related to unobserved values in the data, i.e., the missingness is also related to the feature value itself.

As used herein, a “graph recovery algorithm” refers to a method or technique for recovering a domain structure graph (in some embodiments, a conditional independence graph) based on the collection of samples in the input data. In one or more embodiments, this refers to a uGLAD algorithm.

As used herein, a “probabilistic graphical model” (PGM) refers to a statistical model that encodes complex joint probability distribution using graphs and supports inference over the variables in the domain.

As used herein, a “neural graphical model” (NGM) refers to a computer algorithm or model (e.g., a classification model, regression model, probabilistic graphical model, etc.) that can be tuned or trained based on training input to approximate unknown features or values. In one or more embodiments described herein, an NGM refers to a neural network (e.g, a multi-layer perceptron) having an architecture that learns or approximates functions that specify dependence of a feature's value based on other features' values. In one or more embodiments, the NGM refers to a neural graphical model configured to fit a regression to match the input and output of the neural graphical model corresponding to given input data along with maintaining an associated graph structure constraint using a regularization term. It will be understood that while one or more embodiments described herein refer specifically to an NGM, features described in connection with NGMs and other neural networks may similarly apply to a variety of neural networks and/or neural graphical model(s) or probabilistic graphical models.

As used herein, a “neural graph revealer” (NGR) refers to a method for jointly recovering a graph and fitting a regression function for all features using a neural network at the same time. As such, an NGR combines the steps of domain structure recovery (which results in a graph indicating dependencies between functions) and creating an NGM capable of performing inference.

As used herein, a “graph” or “feature graph” may refer to a data object in which features associated with a collection of samples are represented in a way that can be visualized to show direct connections (representing direct dependencies) between various features. In one or more embodiments described herein, a feature graph refers to a visualization of features and associated connections by way of nodes that represent respective features and connections between the features while satisfying one or more sparsity constraints. More specifically, a sparse graph may include a set of features and corresponding connections that represent some subset of all possible connections between features of the input data where the subset of connections indicates direct connections as determined when applying a probabilistic graphical model (PGM) to the collection of samples and corresponding features. In one or more embodiments, the graph will have a probabilistic interpretation, in which feature Xᵢ and Xⱼ are not connected by an edge if and only if they are conditionally independent given all other features.

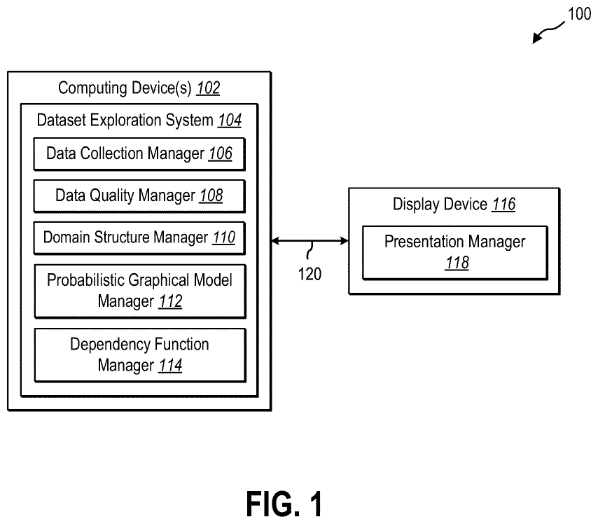

Additional detail will now be provided regarding a dataset exploration system in accordance with one or more example implementations. For example, FIG. 1 illustrates an example environment 100 including one or more computing devices 102 having a dataset exploration system 104 implemented thereon. The computing device 102 may refer to a variety of different computing devices on which a dataset exploration system may be implemented. For example, the computing device 102 may include a mobile device such as a mobile telephone, a smartphone, a personal digital assistant (PDA), a tablet, or a laptop. Additionally, or alternatively, the computing device 102 may include a non-mobile device such as a desktop computer, a server device, or other non-portable device. The computing device 102 (and other devices described herein) may include features and functionality described below.

As shown in FIG. 1, the computing device 102 includes a dataset exploration system 104 implemented thereon. The dataset exploration system 104 may include a number of components. For example, the dataset exploration system 104 may include a data collection manager 106, a data quality manager 108, a domain structure manager 110, a probabilistic graphical model manager 112, and a dependency function manager 114.

While FIG. 1 shows an example implementation in which the components of the dataset exploration system 104 are contained within a single computing device 102, one or more implementations may include components (or sub-components) implemented across multiple computing devices. As an example, features described in connection with generating a domain structure may be performed on separate computing devices from features associated with obtaining input data.

Additional data will now be discussed in further detail in connection with various components of the dataset exploration system 104. For example, in one or more embodiments, the data collection manager 106 facilitates collection of input data, which may include a variety of data types and collections of samples of a wide range in collection sizes. For instance, in one or more embodiments, the data collection manager 106 obtains input data including a table of values in which each row or column represents a sample from a collection of input samples having plurality of features. In this example, each corresponding column (or row) of the respective sample including plurality of features may include any feature values representative of characteristics of the associated feature in that particular sample.

As an illustrative example, the input data may refer to a collection of samples including features and feature values of new chemical compositions. In this example, a set of input data may refer to a table of samples and features in which the samples refer to chemical compositions and features associated with the respective samples. In this example, the input data may be represented by a plurality of rows that each correspond to a particular composition (e.g., a chemical composition) while each column provides a feature, such as heat resistance, friction and viscosity. The features may have associated values, such as a numerical value associated with the corresponding feature of the chemical composition indicating a feature value of the sample. For instance, a first sample may have a feature value of 50 for a feature of viscosity while a second sample may have a feature value of 1.2 for the same feature.

In contrast to the above example, the data collection manager 106 may collect or otherwise obtain unstructured data and generate a table or other structured form of the data. For example, the data collection manager 106 may receive unstructured data and perform one or more operations to convert the data into a table of columns and rows (e.g., tabular data) with corresponding features and their associated features or feature values that are associated with the respective samples.

In one or more embodiments, the input data includes a complete representation of data in which each sample includes all values for all the features. In other implementations, the collected input data may include some but not all features or feature values for all the features when the input data is received. As an example, the input data may include a collection of samples with some of the samples having an incomplete set of feature or feature value data. This incompleteness may be a result of a variety of issues, such as sensor faults or an intentional omission of information from sample subjects (e.g., individuals filling out forms).

As noted above, the feature or feature values may include a variety of data types. For example, the feature or feature value of the input data may include numerical values (e.g., quantitative data type), such as continuous data, and discrete data, or any other form of data. In one or more embodiments, the feature or feature value may be a categorical (e.g., qualitative). For example, the feature or feature value of the input data may include nominal data (e.g., African American, Eurasian, Hispanic, etc), or ordinal data (e.g., HIGH, MEDIUM, LOW). In one or more embodiments, each feature in the same sample for a given input set may have different type of data (continuous, discrete, nominal, ordinal).

Once the input data is collected and organized in a table or other data structure, the data collection manager 106 may proceed to preprocess the input data, such as to normalize the input data and/or to perform covariance matrix calculations as further discussed below.

In one or more embodiments, the data collection manager 106 may normalize the input data. For example, the data collection manager 106 may utilize normalization procedures such as ‘min-max’, ‘mean’, ‘centered log-ratio’, ‘additive log-ratio’, ‘standardized moment’, ‘student's t-statistics’, etc. In one or more embodiments, data normalization may allow to post-process the data without making any assumptions about the distribution of the data.

In one or more embodiments, the data collection manager 106 may perform covariance matrix calculations to describe covariance between two or more features. In one or more embodiments, where two features both have numerical type, a correlation between the two may be calculated using Pearson's correlation coefficient. In one or more embodiments, where two features both have categorical type, the association between the two features may be calculated by using Cramérs V statistic including a bias correction. In one or more embodiments, where one feature is numerical and another feature is categorical, a correlation may be evaluated using correlation ratio, point biserial correlation, or Kruskal-Wallis test by ranks (also known as H test). These covariance matrices may be used by the dataset exploration system when generating one or more models.

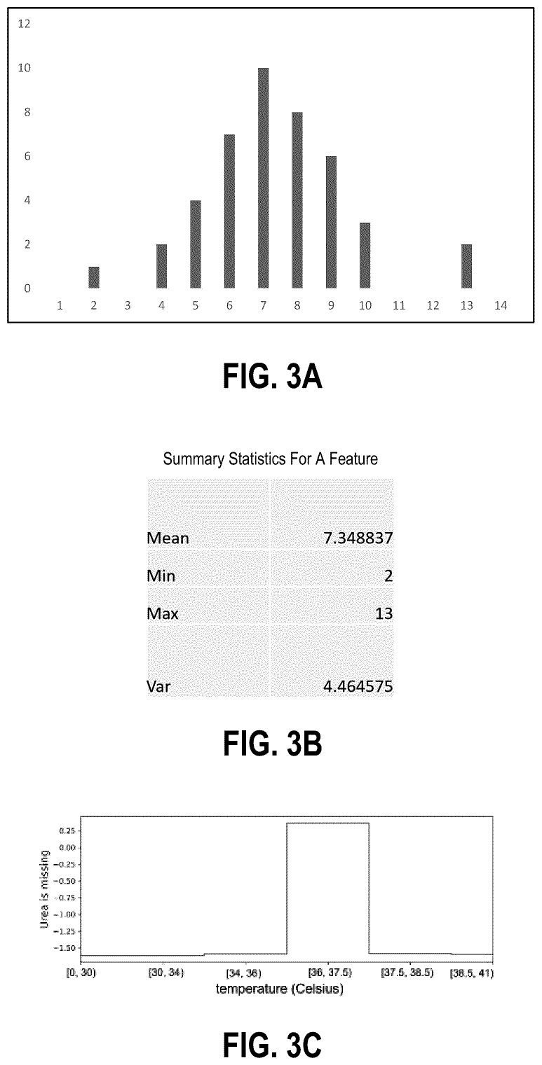

In one or more embodiments, the data quality manager 108 may proceed to analyze the preprocessed input data to compute summary statistics and missingness properties for each feature in the input data. In one or more embodiments, missingness analysis may include missingness rate analysis (overall or over time), missingness type (MCAR, MAR, MNAR), and creating visual graphs to illustrate the dependence of missingness of one feature on a value of another feature, as further discussed in connection to FIG. 3C. In one or more embodiments, the summary statistics may include creating tables to list statistical properties and graphs to illustrate feature ranges and distributions (e.g., histograms, scatter plots, box plots, distribution graphs, etc.), calculating statistical tests, or a combination of two or more methods as further discussed in connection to FIGS. 3A-3B. For example, the data quality manager 108 may provide the visual graphs and tables to a presentation manager 118 via a connection 120 (e.g., wired or wireless connection), to be displayed on the display device 116. By providing summary statistics and missingness properties to the presentation manager 118 to be displayed on the display device 116, the user is given an opportunity to verify data quality before further analyzing the dataset. In one or more embodiments, assessing the quality of the input data may allow the domain structure manager 110, the probabilistic graphical model manager 112 and the dependency function manager 114 to discover meaningful graphs as errors in the data have been flagged.

Once the data quality manager 108 has assessed data quality of the preprocessed input data and provided the user with information to verify data quality, a domain structure manager 110 may create a domain structure graph based on the preprocessed input data. In some embodiments, a domain structure graph will be a conditional independence (CI) graph, which is a type of probabilistic graphical model (PGM) that models direct dependencies between features of a graph. In one or more embodiments, the output of the domain structure graph may provide a visual representation of connections between features. For example, the domain structure graph may represent each feature as a feature node, and a line (also called as ‘edge’ and ‘edge line’) connecting a feature node to another feature node in case there is a correlation or dependency between the two features.

In one or more embodiments, the domain structure manager 110 is provided with preprocessed input data X with M samples and D features, where {X₁, . . . X_{D}} represent the individual features. The CI graph of a set of random variables Xᵢ's is the undirected graph G=(D,E) where (i,j) is not in the edge set if and only if Xᵢ ⊥Xⱼ|X_{D\i,j}, where X_{D\i,j} denotes the vector of all of the random variables except for Xᵢ and Xⱼ. The CI graph represents the partial correlations between the features and the edge weights will range between (−1, 1).

In one or more embodiments, the connections between features are modeled using an undirected graph and can be visually represented by a line connecting feature nodes that show partial correlation strength between the features. For example, the line connecting features may have a value between −1 and +1, wherein a value close to +1 may indicate a strong positive correlation, a value close to −1 may indicate a strong negative correlation, and a value close to 0 may indicate very low correlation or no correlation between the two features. In one or more embodiment, the weight (i.e., thickness) of the edge lines may indicate an absolute strength of the partial correlation.

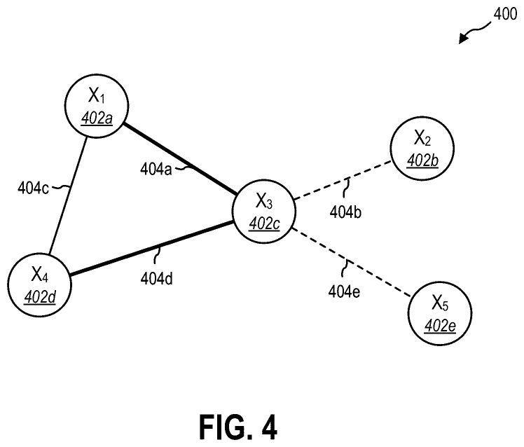

In one or more embodiments, the graphical presentation of a line/edge connecting two feature nodes may have different shapes and/or different colors, or the line may have different weight (i.e., thickness) based on the correlation type of the two feature nodes, as further discussed in connection to FIG. 4. For example, the shape, color, and/or weight of the line may indicate if the correlation or dependence between the two nodes is strong or weak, or positive or negative. In one or more embodiments, the presentation manager 118 may present the domain structure as an output on the display device 116 as further discussed below.

In one or more embodiments, creating a conditional independence graph may include modeling using one or more of (1) a regression-based approaches, (2) methods directly calculating partial correlations and (3) graphical lasso methods. In one or more embodiments, the graph recovered may be a Markov network graph or a Bayesian network graph recovered using Markov and Bayesian network learning approaches including constraint-based methods or score-based methods to recovering undirected and directed graphs, respectively.

Based on the problem formulation, many different optimization algorithms may be used for modeling the conditional independence (CI) graph. One possible optimization algorithm is an uGLAD, which is a deep learning model that can recover sparse graphs in an unsupervised manner. It builds upon and extends the GLAD model which does sparse graph recovery by applying deep unfolding technique on the Alternating Minimization updates under supervision.

Some possible advantages of using uGLAD are that it automatically optimizes sparsity-related regularization parameters leading to better performance than existing algorithms and introduces multi-task learning based consensus strategy for robust handling of missing data in an unsupervised setting. In one or more embodiments, uGLAD uses glasso loss function and incorporates the regularization in the deep model architecture itself which may be implicitly learned during optimization. Glasso loss function is the objective function which is used for estimating sparse inverse covariance matrices. In one or more embodiments, the preprocessed input data (e.g., the covariance matrix calculations performed by the data quality manager 108 in the previous step) acts as input data for the uGLAD. In one or more embodiments, the uGLAD may do multitask learning by optimizing multiple CI graphs at once.

In one or more embodiments, the domain structure manager 110 may provide the conditional independence graph to the presentation manager 118 to be displayed on the display device 116. Some possible advantages of using conditional independence graphs are that they provide an easy-to-understand graph to see the type of relations identified between features, the graph can have a negative-weights, and the graph can be associated with an underlying distribution. Furthermore, the conditional independence graph gives valuable insight into the underlying domain structure.

In one or more embodiments the domain structure graph may encode more complex dependencies between features than partial correlations. For example, when the graph is recovered using a neural graph revealer algorithm.

Once the domain structure has been generated based on the preprocessed input data, a probabilistic model manager 112 trains a probabilistic graphical model (PGM) based on preprocessed input data and (optionally) the domain structure information.

In some embodiments, the probabilistic graphical model manager trains a type of PGM called a neural graphical model (NGM). NGM is a probabilistic graphical model type that accepts diverse input types (e.g., numerical and/or categorical) and does not place restrictions on the form of underlying distributions like some traditional models do. Accordingly, in one or more implementations, the NGM may be used to model input data of a variety of types that may not be as accurately modeled using other forms of graphical models.

The NGM accepts a feature dependency structure that may be given by an expert or learned from data. In one or more embodiments, the dependency structure may have a form of a graph with clearly defined semantics. For example, a Bayesian network graph or a Markov network graph. In one or more embodiments, the dependency structure may be an adjacency matrix. In one or more embodiments, the CI graph or another sparse graph generated by the domain structure manager 110 may be used for the feature dependency structure. Based on the dependency structure, the NGM may be able to represent the probability function over the domain using a deep neural network. The parameterization of such a network can be learned from data efficiently, with a loss function that jointly optimizes adherence to the given dependency structure and fit to the data as discussed in more detail below. The input for NGM includes the preprocessed input data X and a graph G (e.g., tuple (X, G)). In one or more embodiments, the graph G may be the CI graph generated by a domain structure manager 110. In one or more embodiments, the graph G may be provided by an expert user that includes inductive biases and domain knowledge about the underlying system functions. In one or more embodiments, if a graph has not been provided, the graph G may be recovered as a directed acyclic graph (DAG) using one of the Bayesian network learning methods, such as score-based methods. DAG is a direct graph with no directed cycles, consisting of vertices and edges (lines), with each edge directed from one vertex to another, such that there is no way to start at any vertex v and follow a consistently-directed sequence of edges that eventually loop back to v again. DAGs can be used to represent the causal relationship between variables in a system. Before using as an input to the NGMs, DAGs are converted to their undirected versions, by using a standard process called ‘moralization’.

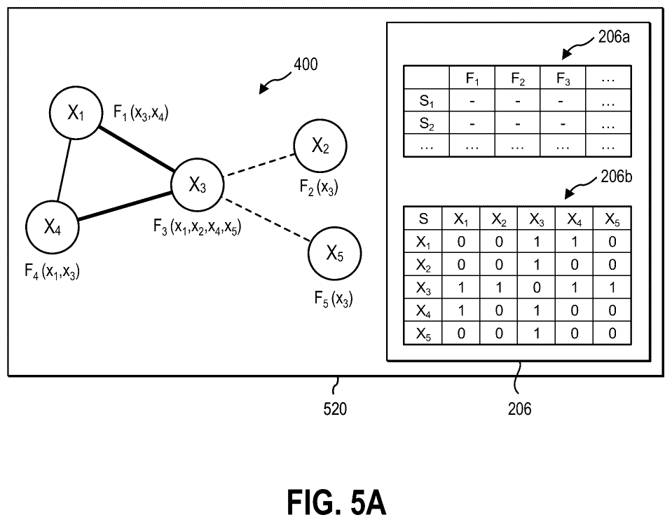

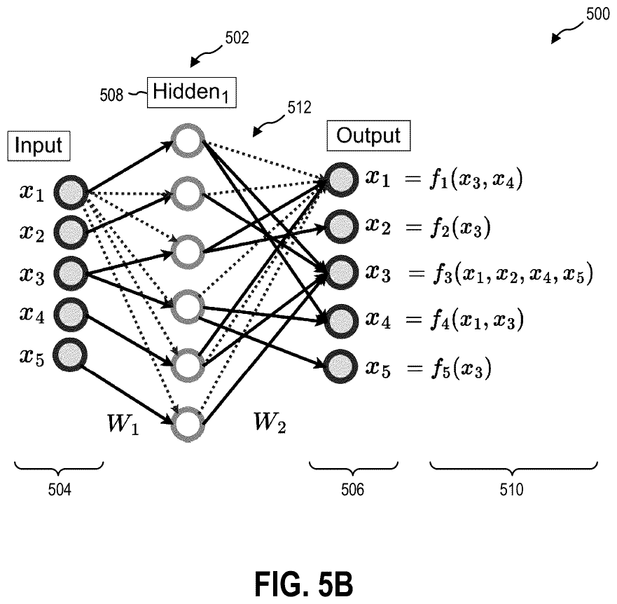

An example of neural view of NGM is provided in FIG. 5B. The neural networks used are multi-layer perceptrons with appropriate input and output dimensions and one or more hidden layers It will be understood that the multilayer perceptron is provided by way of example and is not intended to be limiting of the only type of neural network architecture that may be used in accordance with one or more embodiments described herein.

Specifically, the neural networks focus on the paths from input to output that represent functional dependencies. In one or more embodiments, a neural network with L number of layers with weights (W={W₁, W_{2,}, . . . , W_{L,}} and biases [symbol] ={b₁, b_{2,}, . . . , b_{L,}} can be denoted as [symbol] (·) with non-linearity not mentioned explicitly. In one or more embodiments, a rectified linear unit (ReLU) may be used within the disclosed framework. Applying the neural network to the preprocessed input data X_{D} evaluates the following mathematical expression [symbol] (X_{D})=ReLU (W_{L}·( . . . (W₂·ReLU (W₁·X_{D}+b₁)+b₂) . . . )+b_{L}). The dimensions of the weights and biases may be chosen such that the neural network input and output are units equal to “D” (dimension equal to the number of features in the input data) with the hidden layers dimension (H) remaining a design choice. In one or more embodiments, an initial choice may be set as H=2|D|, and subsequently the dimensions may be adjusted based on the validation loss.

In one or more embodiments, the product of weights of the neural network (Sₙₙ) is expressed with the following equation:

$${S}_{nn} = {\prod }_{l = 1}^{L} \vert {W}_{l} \vert = \vert {W}_{1} \vert \times \vert {W}_{2} \vert \times ⋯ \times \vert {W}_{L} \vert$$

This equation provides path dependences between the input and the output units. For shorthand, we denote Sₙₙ=Πᵢ|Wᵢ|. It is noted that if Sₙₙ(xᵢ, xₒ)=0, then the output unit (xₒ) does not depend on the input (xᵢ). Increasing the layers and hidden dimensions of the neural networks provide richer dependence function complexities.

Using the rich and complex functional representation achieved by using the neural view, the learning task may fit or otherwise cause the neural networks to find parameters that achieve the desired dependency structure S, as encoded by network paths, along with fitting the regression to the preprocessed input data X. Given the preprocessed input data X the goal is to learn the functions described by the NGMs graphical view, as shown in FIG. 5A and discussed in further detail below. These may be obtained by solving the multiple regression problems shown in neural view in FIG. 5B, and as discussed in further detail below. This may be achieved by considering the neural view as a multi-task learning framework. The goal is to find the set of parameters W that minimize the loss expressed as the distance from X_{D}^{k} to f_{W}(X_{D}^{k}) while maintaining the dependency structure provided in the input graph G. Including the structure constraint as a Lagrangian term with [symbol] penalty and a constant λ that acts a tradeoff between fitting the regression and matching the graph dependency structure, we get to the following optimization formulation:

$${arg min}_{W , B} {\sum }_{k = 1}^{M} ‖ {X}_{D}^{k} - {f}_{W , B} ( {X}_{D}^{k} ) {‖}_{2}^{2} + λ log ( ‖ ( {\prod }_{i = 1}^{L} \vert {W}_{i} \vert ) ⋆ {S}^{c} {‖}_{l} )$$

Where S^{c} represents the compliment of the matrix S, which essentially replaces 0 by 1 and vice-versa. The A*B represents the Hadamard operator which does an element-wise matrix multiplication between the same dimension matrices A, B. In this implementation, the individual weights are normalized using [symbol] -norm before taking the product. The regression loss and the structure loss terms are normalized, and appropriate scaling is applied to the input data features. The trained NGM describes the underlying graphical model distributions.

In one or more embodiments, a Neural Graphical Revealer (NGR) method may be used for generating a domain structure and recovering an NGM. NGR is a method for recovering a graph and fitting regression functions for all features using a neural network at the same time. As such, a NGR combines the steps of generating a domain structure, that results in a graph indicating dependencies between functions, and creating an NGM capable of performing inference on the dataset. In NGR method, a learning algorithm is applied to the fully connected multilayer perceptron using preprocessed input data to generate an optimized regression model (e.g., a trained NGR) that indicates functional dependencies between different features of the preprocessed input data. During the training process, some of the network connections may be dropped and their weights set to 0. The NGRs are a type of regression-based approach that can model highly non-linear and complex functional dependencies between features by leveraging the expressive power of neural networks. The NGRs attempt to efficiently merge the sparse graph recovery methods with PGMs into a single flow. The problem setting consists of an input data X with D features and M samples and the task is to recover a sparse graph showing connection between the features and learn a probability distribution over the graph. The system and method for generating a domain structure and recovering a NGR model is further discussed in U.S. patent application Ser. No. 18/313,907 titled “Neural Graph Revealers”, filed on May 8, 2023. While uGLAD expects to have a multivariate Gaussian distribution (e.g., normal distribution) for the input data, NGR does not make that assumption, hence the NGR method may be more suitable for various different use cases.

After the NGM has been recovered, either by using the dependency graph and NGM, or by using NGR, or by using a different probabilistic graphical model, the probabilistic graphical model manager 112 may use the trained model to perform a number of inference tasks. In one or more embodiments, the NGM may be used to compute maximum a posteriori (MAP) values for all variables in a domain given specific evidence on a key variable. For example, a minimum, a maximum, mode or other statistical metric of the prior distribution over a key variable may be used as evidence to compute most likely state for all other variables. In this example, the result would show the user the most likely environment in which a specific value of the key variable could have occurred.

In one or more embodiments, additional variables of interest may be specified and values of interest to serve as evidence and additional inference using these variables and values may be performed. If the variable of interest is categorical, all of its values may be used as evidence or only a user-specified subset of its values may be used as evidence. In one or more embodiments, the MAP values for each feature can be shown on a feature histogram to indicate how typical or unusual a given MAP value is compared to the entire prior distribution over a feature.

In one or more embodiments, the evidence may be given not for just one variable of interest, but a set of variables of interest. If evidence is given to a set of variables of interest, the MAP values or full distributions maybe computed for all other variables, (i.e., for which values were not specified). In one or more embodiments, a user may provide observed evidence or hypothetical evidence in a form of specific value(s) to determine inferences.

In one or more embodiments, the NGM may be used to obtain conditional probability distributions. It is often desirable to get the full conditional probability density function rather than just a point value for any inference query.

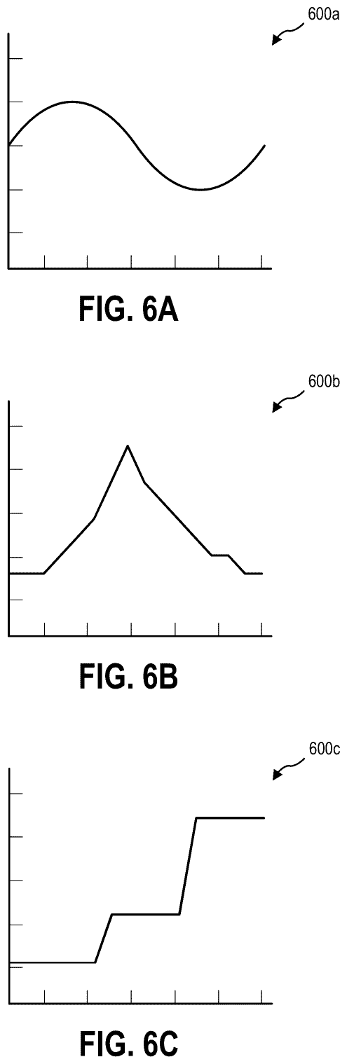

A dependency function can be computed for showing the pairwise relationships between the key variable and its top k most correlated neighbors in the graph, both positively and negatively. Such relationships are often complex and most models that assume linearity cannot truthfully represent them. In contrast, an NGM can represent arbitrarily complex functions. Examples of dependency function are shown and discussed in connection with FIGS. 6A-6C. In some examples, a dependency function can be computed to show pairwise relationship between any two variables in response to user's queries.

The environment 100 further includes a presentation manager 118. In one or more embodiments, the presentation manager 118 may generate tables and visual graphs to provide summary statistics and missingness analysis. For example, the data quality manager 108 may provide visual graphs and tables to the presentation manager 118, to be displayed on the display device 116. By providing summary statistics and missingness properties to the presentation manager 118 to be displayed on the display device 116, the user is given an opportunity to verify data quality before further analyzing the dataset.

In one or more embodiments, the presentation manager 118 may generate a graph representative of the dependency structure that is determined for a given set of input data. For example, the presentation manager 118 may generate a graph including nodes and lines (e.g., edges) that are representative of features and dependencies between the features of a given dataset. The presentation manager 118 may additionally cause the graph to be displayed or otherwise presented via a graphical user interface (GUI) on a display device 116 (e.g., a client device, such as a personal computer or mobile device).

In one or more embodiments, the presentation manager 118 may generate a table to show inference results to a user of a display device. The probabilistic graphical model manager 112 may generate MAP values in a table form for all variables in a domain given specific value on a key variable. For example, the table may provide information about the most likely environment in which the given specific value on a key variable may occur.

In one or more embodiments, the presentation manager 118 may present a full distribution view for all variables without evidence conditional on the evidence provided.

In one or more embodiments, the presentation manager 118 may generate a set of graphs representing dependency functions. For example, a dependency function manager 114 may compute a dependency function showing a pairwise relationships between key variable and its top k most correlated neighbors in the graph, both positively and negatively or top k neighbors in terms of dependence for graphs representing dependencies more complex than correlations

In one or more embodiments, the presentation manager may include an interactive component to solicit and obtain information from a user on variables of interest and values of interest, perform additional inference tasks and additional dependency function analysis and show the results of these tasks to the user.

While FIG. 1 illustrates an example in which the display device 116 is separate from the computing device(s) 102, in one or more implementations, the display device 116 is implemented as a part of the computing device 102. In one or more embodiments, presentation manager 118 is implemented on the computing device 102 (e.g., rather than on the display device 116, as shown in FIG. 1). Indeed, FIG. 1 illustrates a sample environment 100, and other implementations may include different combinations of the components of the data exploration system 104 and/or the presentation system 118 implemented on a single device or across multiple devices.

In one or more embodiments, the dataset exploration system 104 may provide graphical and/or numerical information to a user through a display device 116. For example, the dataset exploration system 104 may send graphical and/or numerical data to a presentation manager 118 on the display device 116. In one or more embodiments, the dataset exploration system 104 may be connected to the display device 116 through a wired or wireless interface 120. For example, the interface 120 may be a wireless Bluetooth, Wi-Fi, cellular interface, or other wireless network. In one or more embodiments, the computing device(s) 102 is electronically connected to the display device 116 through a connector 120, when the computing device 102 and display device 116 are physically included in the same device (e.g., a mobile phone, or a laptop).

In one or more embodiments, the dataset exploration system 104 is able to present an output via the display device 116 based at least one of the summary statistics, the missingness analysis, the generated domain structure, the recovered PGM, the inference results and the dependency functions. In one or more embodiments, the output may be a domain structure 208 generated from the preprocessed data as discussed above. In one or more embodiments, the output may be statistical data 214, such as tabular data, visual graphs on feature values (e.g., histograms, scatter plots, box plots, distribution graphs) as discussed above. In one or more embodiments, the output 214 may be a numerical data providing sorted feature values, or calculated statistical tests that identify for each feature missingness type, missingness rate and missingness dependence on other features. In one or more embodiments, the output 214 may include a combination of graphical and numerical data. In one or more embodiments, the output may be the PGM 210 based on the preprocessed input data 206 and the graph 208 as discussed above. In one or more embodiments, the output may be conditional probability density functions calculated by using the PGM. In one or more embodiments, the output may be graphical dependency charts 212 created by the dependency function manager 114. Examples in connection with generating and presenting each of these outputs will be discussed in further detail below.

In one or more embodiments, the presentation manager 118 presents an interactive view of the graph. For example, in addition to generally showing all nodes associated with corresponding features and a set of lines (edges) representing dependencies learned by the domain structure manager 110 and/or the probabilistic graphical model manager 112 that satisfies one or more sparsity constraints, the presentation manager 118 may include interactive features that enable a user to view attributes or other details of specific features and/or dependencies within the graph. In one or more embodiments, a user may select a node and view dependencies to other features and associated strength of the connections via a feature-specific view.

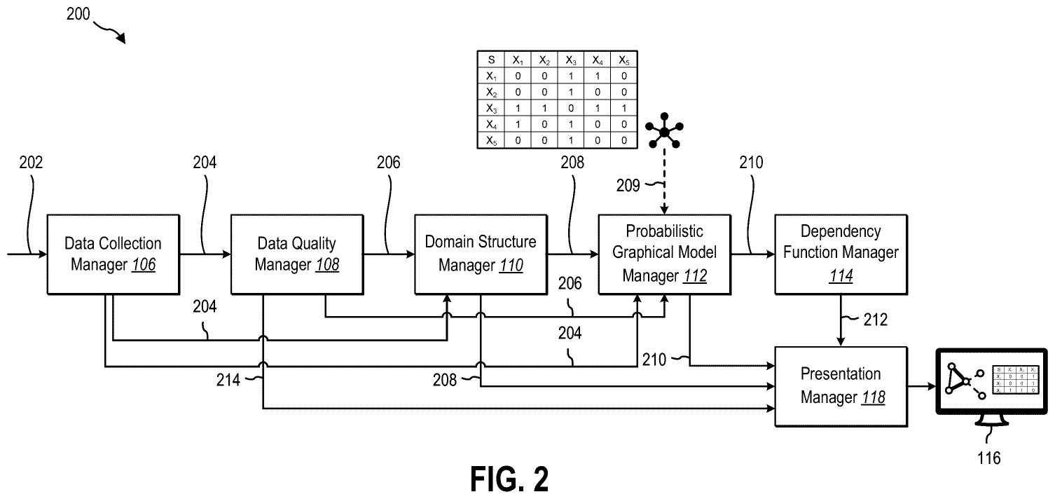

FIG. 2 illustrates an example workflow 200 showing a possible implementation of the data exploration system in accordance with one or more embodiments. It will be appreciated the components shown in FIG. 2 may have similar features as discussed above in connection with similar components shown in FIG. 1.

As shown in FIG. 2, the data collection manager 106 may receive or otherwise obtain input data 202. The input data may refer to structured data or unstructured data (e.g., data that is not necessarily organized in rows and columns). In the example shown in FIG. 2, the data collection manager receives unstructured input data 202 and organizes the input data 202 in rows and columns to generate a collection of input data (tabular data) 204 having a form that can be analyzed by data quality manager 108.

In one or more embodiments, the data collection manager 106 may further preprocess the data by normalizing the collection of input data 204. In one or more embodiments, the data collection manager 106 may perform covariance matrix calculations to describe covariance between two or more features. These covariance matrixes may be used by the domain structure manager 110 and/or the probabilistic graphical model manager 112 when generating domain structure and/or one or more models.

In one or more embodiments, the data quality manager 108 may obtain the preprocessed input data 204 from the data collection manager 106 and assess data quality of the preprocessed input data. For example, the data quality assessment may include collecting summary statistics and performing missingness analysis. The results of such summary statistics and missingness properties may be provided to the presentation manager 118, as shown by line 214 in FIG. 2.

As shown in FIG. 2, the domain structure manager 110 may receive the preprocessed input data 204 and the data quality assessment 206 for further processing. In particular, the domain structure manager 110 may create a domain structure graph 208 based on the preprocessed input data 204. A domain structure graph 208, which may be in some implementations a conditional independence (CI) graph, is a type of probabilistic graphical model (PGM) that model direct dependencies between features as an undirected graph. In one or more embodiments, the output of the domain structure graph 208 may provide a visual representation of dependencies between features. For example, the domain structure graph 208 may represent each feature as a feature node, and a line (also called as ‘edge’) connecting a feature node to another feature node in case there is a correlation or dependence between the two features. The CI graph 208 gives valuable insight into the underlying domain structure. In some embodiments, the domain structure graph represents complex non-linear dependencies between features.

As shown in FIG. 2, the probabilistic graphical model manager 112 may receive both the preprocessed input data 204 and the domain structure graph 208 or alternatively an experts graph 209 provided by an expert. In one or more embodiments, if neither domain structure graph 208 nor the experts graph 209 have been provided, a graph may be recovered using any of the previously specified methods, such as regression based, direct estimation of partial correlations, graphical lasso methods recovery methods, Markov or Bayesian network learning algorithms as discussed in connection to FIG. 1.

The probabilistic graphical model manager 112 trains a probabilistic graphical model (PGM) 210 as previously discussed in connection to FIG. 1. The input for probabilistic graphical model manager 112 includes the preprocessed input data (X) 206 and (optionally) a graph (G) (e.g., tuple (X, G)). In one or more embodiments, the graph (G) may be the CI graph 208 generated by a domain structure manager 110, the experts graph 209 provided by an expert user, or a graph recovered by the domain structure manager 112. In some embodiments, a graph will not be needed as the algorithm used can recover the graph and train a PGM at the same time, as is the case of a Neural Graph Revealer model.

As shown in FIG. 2, the probabilistic graphical model manager 112 may use the recovered PGM to draw inferences. In one or more embodiments, the probabilistic graphical model manager 112 may also receive the preprocessed input data 206. In one or more embodiments, the PGM may be used to compute maximum a-posteriori (MAP) values for all variables in a domain given specific evidence (i.e. values) on a key variable or on several key variables. For example, a minimum, a maximum, and mode of the prior distribution over a key variable may be used as evidence and compute most likely state for all other variables.

Once the PGM is recovered, the probabilistic graphical model manager 112 may use the PGM to obtain conditional probability distributions. It is often desirable to get the full conditional probability density function rather than just a point value for any inference query.

As shown in FIG. 2, the dependency function manager 114 may use the PGM model to generate a dependency function showing pairwise relationships between the key variable and its top k most strongly dependent neighbors or any other pair of features. An example of graphical representation of a dependency function is provided in connection to FIGS. 6A-6C.

As shown in FIG. 2, one or more outputs are provided to the display device 116. In one or more embodiments, the output may include one or more of the following; summary statistics and/or missingness analysis data 214 generated by the data quality manager 108, the domain structure data 208 generated by the domain structure manager 110, the PGM data and inference results 210 recovered by the probabilistic graphical model manager 112, and dependency functions 212 generated by the dependency function manager 114. For example, the PGM data 210 may include one or more of PGM, MAP values for all features, and/or conditional probability distributions.

FIGS. 3A-3B illustrates an example output of summary statistics, according to at least one or more embodiments. FIG. 3A provides an example of a histogram showing the distribution of values for one feature. In the FIG. 3A, a distribution of values is shown in which a majority of the observed values are between four (4) and ten (10), with a few samples falling out this range of values. FIG. 3B provides an example of statistical analysis performed on the data set shown in FIG. 3A. As shown in FIG. 3B, the dataset has a minimum value of 2, maximum value of 13, a mean is 7.348837, and variance is 4.464575. These statistical measures can be used to describe the dataset shown in FIG. 3A. In one or more embodiments, the statistical analysis may further include median, mode, standard deviation, skewness, and/or kurtosis among other statistical measures.

FIG. 3C illustrates an example output of a missingness analysis, according to one or more embodiments. In FIG. 3C the missingness of feature “Urea” is shown to be dependent on feature “temperature”. The graph in FIG. 3C shows that feature “Urea” is not missing completely at random (MCAR). When temperature is between 36 C and 37.5 C, the value for the feature “Urea” is very likely to be missing. When the temperature is above 37.5 C or below 36 C the value for feature “Urea” is less likely to be missing. A user may conclude from FIG. 3C that urea test is less often ordered for patients whose temperature is about normal (i.e., between 36 C and 37.5 C).

FIG. 4 illustrates an example of a domain structure graph 400, according to one or more embodiments. In one or more embodiments, the domain structure graph 400 may provide a visual representation of connections between features. In the example shown in FIG. 4, the domain structure graph 400 represents each feature (x₁, x₂, x₃, x₄, and x₅) as a feature node (402A, 402B, 402C, 402D, and 402E), and a line (also called as ‘edge’) (404A, 404B, 404C, 404D, and 404E) connecting a feature node to another feature node representing a correlation or dependence between the two features.

In one or more embodiments, the graphical presentation of a line/edge connecting two feature nodes may have different shapes and/or different colors, or the line may have different weight or thickness based on the correlation type of the two feature nodes. In the example shown in FIG. 4 the shape of the line indicates if the correlation is positive or negative, and the weight or thickness of the line indicates if the correlation or dependence between the two nodes is strong or weak. In one or more embodiments, a presentation manager 118 may present the domain structure 400 as an output on a display device 116.

In the example shown in FIG. 4, the domain structure graph 400 shows that feature x₁ correlates with features x₃ and x₄, feature x₂ correlates with feature x₃, feature x₄ correlates with features x₁ and x₃, feature x₅ correlates with x₃, and feature x₃ correlates with all the other features. Furthermore, based on the style of the edge/line, the domain structure graph 400 also shows that there is a positive correlation (solid line) between x₁ and x₃, x₁, and x₄, and x₃ and x₄. The domain structure graph 400 further shows that there is a negative correlation (dashed line) between x₂ and x₃, and between x₃ and x₅.

In addition, the domain structure graph 400 shows that there is a strong correlation (thick line) between x₁ and x₃, and between x₃ and x₄, while all the other correlations are less strong. Furthermore, the domain structure graph 400 also reveals which features do not correlate at all, have a negative correlation, or which have a very weak correlation; x₁ and x₂, x₁ and x₅, x₂ and x₄, x₂ and x₅, and finally x₄ and x₅. Each of these respective types of correlations may be illustrated in a variety of ways (e.g., dashed lines, solid lines, thick/thin lines). Other implementations may include colors or shades that illustrate the strength or weakness of the respective connections.

In one or more embodiments, the dependencies between features recovered by the domain structure manager will be more complex than correlations and not easily classified as positive or negative. In such cases all edges representing the dependencies may be of the same type and weight regardless of the strength of the dependency.

In practice, the dependency functions for each feature node may be presented as follows showing interdependency of features from a given set of features from a dataset with each feature's value being a function of the values of its neighbors in the graph:

$$\begin{matrix}x 1 = {f}_{1} ( {x}_{3} , {x}_{4} ) \\ x 2 = {f}_{2} ( {x}_{3} ) \\ x 3 = {f}_{3} ( {x}_{1} , {x}_{2} , {x}_{4} , {x}_{5} ) \\ x 4 = {f}_{4} ( {x}_{1} , {x}_{3} ) \\ x 5 = {f}_{5} ( {x}_{3} )\end{matrix}$$

FIG. 5A illustrates an example of an input data 520 for the probabilistic graphical model manager 112, according to one or more embodiments. In the example illustrated in FIG. 5A, the input graph for the probabilistic graphical model manager 112 is the graph 400, generated by the domain structure manager 110, as discussed above. In addition to the graph 400, the probabilistic graphical model manager 112 will also need the preprocessed input data 206 as discussed above. In one or more embodiments, the preprocessed input data 206 may include a covariance matrix calculated by component(s) of the dataset exploration system 104, or any other matrix showing associated dependencies between features.

FIG. 5B illustrates an example of a neural view of NGM 500, according to one or more embodiments. In the illustrated example, a neural network 502 (e.g., a multilayer perceptron) is provided with both input features 504 and output features 506 represented as x₁, x₂, x₃, x₄, and x₅. The output features 506 are dependent only on those input features 504 discovered by the domain structure graph 400.

Indeed, as shown in FIG. 5B, the fully trained neural network 502 shows input features 504 being connected to only those output features 506 (e.g., by way of the hidden layer 508 being connected to each input feature 504 and output feature 506). It will be appreciated that while the example neural network 502 shows five variables with a single hidden layer 508 with six nodes in the layer, one or more implementations include a framework including any number of hidden layers 508 with any dimension(s) that are connected to any number of features, thus providing the possibility of a very rich and complex functional representation of the various features.

Indeed, the bigger the size of the neural network 502 (e.g., number of hidden layers 508, hidden layer dimensions in terms of the number of units), the richer the functional representation of the features will be (e.g., output functions 510). The dashed lines connecting the input features 504 to hidden layer 508 and further to the output feature 506 show which input features 504 do not have a dependence or relation to those output features 506. For the sake of clarity, not all dashed lines of the neural network 502 are necessarily shown in FIG. 5B.

It will be noted that because the neural network 502 trained on the input data 504 is capable of representing complex distributions, the features described herein in connection with generating an NGM may be scalable to a large number of data points while also maintaining sparsity. This is a significant improvement over conventional models that are limited to specific types of data or that cannot scale to larger datasets that include complex distributions of feature values.

In one or more embodiments, the dataset exploration system 104 applies the training procedure to the neural network 502 using the input data 504 and a given graph G to fit output functions for the various features. As shown in FIG. 5B, the resulting output includes the NGM 500 in which paths 512 through the neural network 502 may be used in output functions 510 for each of the features. In particular, the output functions 510 may include formulas that are functions of one or more of the input features 504. In this example, each output feature 506 is expressed as a function of a set of one or more input features 504.

In one or more embodiments, the dataset exploration system 104 may use a neural graph revealer (NGR) model to recover the dependency structure and fit output functions in one step to recover an NGM.

FIGS. 6A-6C illustrate an example of dependency functions 600A, 600B and 600C showing a pairwise relationships between a key variable and its top k most correlated neighbors identified in the graph (or any other pair of features), according to one or more embodiments. Such relationships are often complex and most models that assume linearity cannot truthfully represent them. In contrast, an NGM can represent arbitrarily complex functions. As can be seen in FIG. 6A the dependency function 600A appears to be a third-degree polynomial function. The dependency function 600B shown in FIG. 6B appears to be a piecewise linear function, and the dependency function 600C shown in FIG. 6C appears to have an incremental dependency increase.

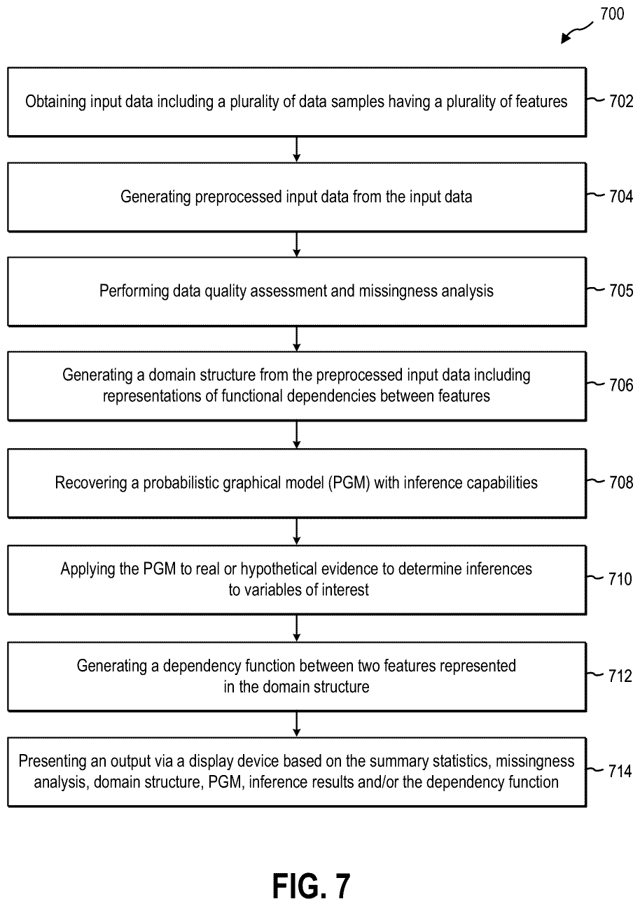

FIG. 7 illustrates an example of flow chart including a series of acts 700 for dataset exploration based on a collection of input data, according to one or more embodiments. While FIG. 7 illustrates acts according to one or more embodiments, alternative embodiments may omit, add to, reorder, and/or modify any of the acts shown in FIG. 7. The acts of FIG. 7 can be performed as part of a method. Alternatively, a non-transitory computer-readable medium can include instructions that, when executed by one or more processors, cause a computing device to perform the acts of FIG. 7. In still further embodiments, a system can perform the acts of FIG. 7.

As shown in FIG. 7, the series of acts 700 may include an act 702 of obtaining input data including a plurality of data samples, each of the plurality of data samples having a plurality of features. The sample features may include two or more types of data. For example, the sample features may include numerical types of data (continuous and discrete), categorical types of data (nominal and ordinal), or a combination or one or more. In one or more embodiments, the input data may be structured data, including all relevant data in tabular form in a single data file. In one or more embodiments, the input data may be unstructured data. For example, in one or more embodiments, the dataset exploration system may perform one or more operations to convert the input data into a table of columns and rows. In one or more embodiments, the input data includes a complete representation of data in which each sample includes all feature values for all the features. In one or more embodiments, the collected input data may include some but not all features or feature values for all the features when the input data is received. As an example, the input data may include a collection of samples with some of the samples having an incomplete set of feature or feature value data.

The series of acts 700 may also include an act 704 of generating preprocessed input data from the input data. For example, in one or more implementations, the act 704 includes generating preprocessed input data, wherein the preprocessing of input data includes performing one or more of a data normalization, a covariance matrix calculations. In one or more implementations, generating the preprocessed input data includes one or more of performing data normalization, calculating a covariance matrix. As shown in FIG. 7, the series of acts 700 includes an act 705 of performing data quality assessment and missingness analysis. In one or more implementations, the act 705 includes assessing data quality of the preprocessed input data where assessing data quality includes one or more of collecting summary statistics and performing missingness analysis. The series of acts 700 may also include assessing data quality, which may include performing missingness analysis for each feature of the plurality of features to determine a missingness rate, a missingness rate over time, a missingness type, and a missingness dependence on other features. For example, the missingness type may be one or more of a missing completely at random (MCAR), missing at random (MAR), and missing not at random (MNAR).

In one or more embodiments, the act of performing summary statistics and missingness analysis may include creating visual graphs on feature values. For example, creating histograms, scatter plots, box plots, distribution graphs, etc. Some examples of visual graphs are provided in connection to FIG. 3A-3C. In one or more embodiments, performing summary statistics and missingness analysis may include calculating statistical tests to identify feature distributions. In one or more embodiments performing missingness analysis includes performing at least one or more of a missingness analysis for each feature including a missingness rate, a missingness rate over time, a missingness type, and a missingness dependence on other features. For example, the missingness type may be one or more of a missing completely at random (MCAR), missing at random (MAR), and missing not at random (MNAR).

In one or more embodiments, wherein the preprocessing input data includes a data normalization, the data normalization may include utilizing normalization procedures such as ‘min-max’, ‘mean’, ‘centered log-ratio’, ‘additive log-ratio’, ‘standardized moment’, and ‘student's t-statistics.’.

In one or more embodiments, wherein the preprocessing input data includes performing a covariance matrix calculations, the covariance matrix calculations are performed to describe covariance between two or more features and to be used by the dataset exploration system when generating one or more models. In one or more embodiments, where two features both have numerical type, a correlation between the two may be calculated using Pearson's correlation coefficient. In one or more embodiments, where two features both have categorical type, the association between the two features may be calculated by using Cramérs V statistic including a bias correction. In one or more embodiments, where one feature is numerical and another feature is categorical, a correlation may be evaluated using correlation ratio, point biserial correlation, or Kruskal-Wallis test by ranks (also known as H test).

The series of acts 700 may also include an act 706 of generating a domain structure from the preprocessed input data including representations of functional dependencies between features. For example, in one or more implementations, the act 706 includes generating domain a structure from the preprocessed input data, the domain structure including representations of functional dependencies between features of the plurality of data samples. In one or more embodiments, the domain structure may be a conditional independence (CI) graph that models direct dependencies between features as an undirected graph. In one or more embodiments, generating a conditional independence graph may include modeling using one or more of (1) a regression-based methods (2) a direct partial correlation estimation methods (3) a graphical lasso approaches and (4) Markov network approach, etc.

The series of acts 700 may also include an act 708 of recovering a probabilistic graphical model (PGM) trained to fit probabilistic density function over the plurality of features based on the preprocessed input data and, in some embodiments, the domain structure. In one or more embodiments, the PGM trained to fit probabilistic density function over the plurality of features is a neural graphical model (NGM). In one or more embodiments, uGLAD may be used for modeling the domain structure (e.g., a CI graph) that is later used to recover the NGM. uGLAD, is a deep learning model that can recover sparse graphs in an unsupervised manner. It builds upon and extends the GLAD (Graph Learning via apply deep unfolding on the Alternating Minimization updates) model, which recovers sparse graphs under supervision. In one or more embodiments, the domain structure used for recovering the NGM may be a Bayesian network graph, a Markov network graph, or a CI graph. In one or more embodiments, the NGM is trained to match an output (e.g., a feature value 50 for viscosity) to an input value (e.g., the same feature value 50 for viscosity) using the preprocessed data while maintaining the given domain structure.

In one or more embodiments, NGR (neural graph revealer) optimization algorithm may be used for both generating the domain structure act 706 and recovering the NGM act 708. In one or more embodiments, applying NGR further comprises applying a training algorithm to a fully connected multilayer perceptron using the preprocessed input data to generate an optimized regression model that indicates functional dependencies between different features of the preprocessed input data.

The series of acts 700 may also include an act 710 of applying the PGM to observed or hypothetical evidence in form of specific values assigned to a subset of features to determine inference results including conditional distribution and maximum a posteriori (MAP) values for one or more variables of interest given evidence. In one or more embodiments, a user may provide an observed evidence or a hypothetical evidence in a form of specific value to determine inferences.

The series of acts 700 may also include an act 712 of generating a dependency function between two features represented in the domain structure based on the PGM. For example, in one or more implementations, the act 712 includes generating a dependency function between two features represented in the domain structure based on the NGM. In one or more embodiments, the dependency functions show the pairwise relationships between a key variable and its top k most correlated neighbors in a graph, based on the domain structure.

The series of acts 700 may also include an act 714 of presenting an output via a display device based on one or more of the summary statistics, the missingness analysis, the domain structure, the PGM, the inference results, and/or the dependency function. In one or more embodiments, the output may provide a visual representation of dependencies between features (e.g., the domain structure graph). For example, the domain structure graph may represent each feature as a feature node, and a line (also called as ‘edge’) connecting a feature node to another feature node in case there is a correlation or dependence between the two features. In one or more embodiments, the graphical presentation of a line/edge connecting two feature nodes may have different shapes and/or different colors, or the line may have different weight based on the correlation type of the two feature nodes. For example, the shape, color, and/or weight of the line may indicate if the correlation or dependence between the two nodes is direct-indirect, strong-weak, or positive-negative.

In one or more embodiments, the act 714 of presenting an output via a display device may further include summary statistics, such as visual graphs (e.g., histograms, scatter plots, box plots, distribution graphs), tabular data (e.g., missingness rate and type, dependence on other features), or a combination of visual graphs and tabular data on feature values.

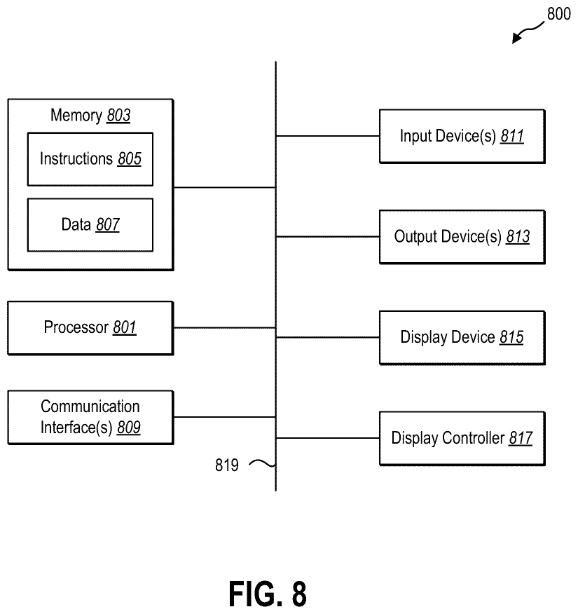

FIG. 8 illustrates certain components that may be included within a computer system 800. One or more computer systems 800 may be used to implement the various devices, components, and systems described herein.

The computer system 800 includes a processor 801. The processor 801 may be a general-purpose single- or multi-chip microprocessor (e.g., an Advanced RISC (Reduced Instruction Set Computer) Machine (ARM)), a special-purpose microprocessor (e.g., a digital signal processor (DSP)), a microcontroller, a programmable gate array, etc. The processor 801 may be referred to as a central processing unit (CPU). Although just a single processor 801 is shown in the computer system 800 of FIG. 8, in an alternative configuration, a combination of processors (e.g., an ARM and DSP) could be used. In one or more embodiments, the computer system 800 further includes one or more graphics processing units (GPUs), which can provide processing services related to both neural network training and graph generation.

The computer system 800 also includes memory 803 in electronic communication with the processor 801. The memory 803 may be any electronic component capable of storing electronic information. For example, the memory 803 may be embodied as random-access memory (RAM), read-only memory (ROM), magnetic disk storage media, optical storage media, flash memory devices in RAM, on-board memory included with the processor, erasable programmable read-only memory (EPROM), electrically erasable programmable read-only memory (EEPROM) memory, registers, and so forth, including combinations thereof.

Instructions 805 and data 807 may be stored in the memory 803. The instructions 805 may be executable by the processor 801 to implement some or all of the functionality disclosed herein. Executing the instructions 805 may involve the use of the data 807 that is stored in the memory 803. Any of the various examples of modules and components described herein may be implemented, partially or wholly, as instructions 805 stored in memory 803 and executed by the processor 801. Any of the various examples of data described herein may be among the data 807 that is stored in memory 803 and used during execution of the instructions 805 by the processor 801.

A computer system 800 may also include one or more communication interfaces 809 for communicating with other electronic devices. The communication interface(s) 809 may be based on wired communication technology, wireless communication technology, or both. Some examples of communication interfaces 809 include a Universal Serial Bus (USB), an Ethernet adapter, a wireless adapter that operates in accordance with an Institute of Electrical and Electronics Engineers (IEEE) 802.11 wireless communication protocol, a Bluetooth® wireless communication adapter, and an infrared (IR) communication port.

A computer system 800 may also include one or more input devices 811 and one or more output devices 813. Some examples of input devices 811 include a keyboard, mouse, microphone, remote control device, button, joystick, trackball, touchpad, and lightpen. Some examples of output devices 813 include a speaker and a printer. One specific type of output device that is typically included in a computer system 800 is a display device 815. Display devices 815 used with embodiments disclosed herein may utilize any suitable image projection technology, such as liquid crystal display (LCD), light-emitting diode (LED), gas plasma, electroluminescence, or the like. A display controller 817 may also be provided, for converting data 807 stored in the memory 803 into text, graphics, and/or moving images (as appropriate) shown on the display device 815.

The various components of the computer system 800 may be coupled together by one or more buses, which may include a power bus, a control signal bus, a status signal bus, a data bus, etc. For the sake of clarity, the various buses are illustrated in FIG. 8 as a bus system 819.

The techniques described herein may be implemented in hardware, software, firmware, or any combination thereof, unless specifically described as being implemented in a specific manner. Any features described as modules, components, or the like may also be implemented together in an integrated logic device or separately as discrete but interoperable logic devices. If implemented in software, the techniques may be realized at least in part by a non-transitory processor-readable storage medium comprising instructions that, when executed by at least one processor, perform one or more of the methods described herein. The instructions may be organized into routines, programs, objects, components, data structures, etc., which may perform particular tasks and/or implement particular datatypes, and which may be combined or distributed as desired in various embodiments.

The steps and/or actions of the methods described herein may be interchanged with one another without departing from the scope of the claims. In other words, unless a specific order of steps or actions is required for proper operation of the method that is being described, the order and/or use of specific steps and/or actions may be modified without departing from the scope of the claims.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. For example, any element or feature described in relation to an embodiment herein may be combinable with any element or feature of any other embodiment described herein, where compatible.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. In a computing environment including one or more server devices hosting services thereon, a method for generating and presenting insights on collections of data samples, the method comprising:
obtaining input data including a plurality of data samples, each of the plurality of data samples having plurality of features;
generating preprocessed input data, wherein generating the preprocessed input data includes one or more of performing data normalization and calculating a covariance matrix;
assessing data quality of the preprocessed input data, wherein assessing data quality includes one or more of collecting summary statistics and performing missingness analysis;
generating a domain structure from the preprocessed input data, the domain structure including representations of functional dependencies between features of the plurality of data samples;
recovering a probabilistic graphical model (PGM) trained to fit a probabilistic density function over the plurality of features based on the preprocessed input data and the domain structure;
applying the PGM to observed or hypothetical evidence in a form of specific values assigned to a subset of features to determine inference results including conditional distribution and maximum a posteriori (MAP) values for one or more variables of interest given evidence;
generating a dependency function between two features represented in the domain structure based on the PGM; and
presenting an output via a display device based on one or more of the summary statistics, the missingness analysis, the domain structure, the PGM, the inference results, and the dependency function.

2. The method of claim 1, wherein the plurality of features include multiple datatypes including two or more of a continuous numeric type, discrete numeric type, nominal categorical type, or ordinal categorical type.

3. The method of claim 1, wherein assessing data quality includes performing missingness analysis for each feature of the plurality of features to determine a missingness rate, a missingness rate over time, a missingness type, and a missingness dependence on other features.

4. The method of claim 3, wherein the missingness type is one or more of a missing completely at random (MCAR), missing at random (MAR), and missing not at random (MNAR).

5. The method of claim 1, wherein calculating the covariance matrix includes calculating covariance between two or more features of the plurality of features.

6. The method of claim 1, wherein the domain structure is a conditional independence (CI) graph.

7. The method of claim 6, wherein the CI graph is modeled using at least one of a regression-based approach with graph sparsity constraints, a partial correlation estimation approach, a graphical lasso approach, or a Markov networks approach.

8. The method of claim 7, wherein the PGM is a neural graphical model (NGM).

9. The method of claim 8 wherein recovering the NGM includes modeling the CI graph obtained using a uGLAD optimization algorithm.

10. The method of claim 8, wherein generating the domain structure and recovering the NGM are performed using a neural graph revealer (NGR) optimization algorithm.

11. The method of claim 10, wherein using the NGR optimization algorithm includes applying a training algorithm to a randomly initialized neural network based architecture (eg. a fully connected multilayer perceptron) using the preprocessed input data to generate an optimized regression model that indicates functional dependencies between different features of the preprocessed input data.

12. The method of claim 1, wherein applying the PGM to the observed or hypothetical evidence includes computing one or more of maximum a posteriori (MAP) values and conditional probability distributions.

13. The method of claim 1, further comprising receiving an interaction input from a user in connection with the observed or hypothetical evidence, or in connection with dependency function computation, wherein presenting the output via the display device is further based on the received interaction input.

14. A system comprising:
at least one processor;
memory in electronic communication with the at least one processor; and
instructions stored in the memory, the instructions being executable by the at least one processor to;
obtain input data including a plurality of data samples, each of the plurality of data samples having plurality of features;
generate preprocessed input data, wherein generating the preprocessed input data includes one or more of performing data normalization and calculating a covariance matrix;
assess data quality of the preprocessed input data, wherein assessing data quality includes one or more of collecting summary statistics and performing missingness analysis;
generate a domain structure from the preprocessed input data, the domain structure including representations of functional dependencies between features of the plurality of data samples;
recover a probabilistic graphical model (PGM) trained to fit a probabilistic density function over the plurality of features based on the preprocessed input data and the domain structure;
apply the PGM to observed or hypothetical evidence in a form of specific values assigned to a subset of features to determine inference results including conditional distribution and maximum a posteriori (MAP) values for one or more variables of interest given evidence;
generate a dependency function between two features represented in the domain structure based on the PGM; and
present an output via a display device based on one or more of the summary statistics, the missingness analysis, the domain structure, the PGM, the inference results, and the dependency function.

15. The system of claim 14, wherein the domain structure is a conditional independence (CI) graph.

16. The system of claim 15, wherein the CI graph is modeled using at least one of a regression-based approach with graph sparsity constraints, a partial correlation estimation approach, a graphical lasso approach, or a Markov networks approach.

17. The system of claim 15, wherein the PGM is a neural graphical model (NGM).

18. The system of claim 17, wherein recovering the NGM includes modeling the CI graph obtained using a uGLAD optimization algorithm.

19. The system of claim 17, wherein generating the domain structure and recovering the NGM are performed using a neural graph revealer (NGR) optimization algorithm.

20. A non-transitory computer readable medium storing instructions thereon that, when executed by at least one processor, cause a computing device to:
obtain input data including a plurality of data samples, each of the plurality of data samples having plurality of features;
generate preprocessed input data, wherein generating the preprocessed input data includes one or more of performing data normalization and calculating a covariance matrix;
assess data quality of the preprocessed input data, wherein assessing data quality includes one or more of collecting summary statistics and performing missingness analysis;
generate a domain structure from the preprocessed input data, the domain structure including representations of functional dependencies between features of the plurality of data samples;
recover a probabilistic graphical model (PGM) trained to fit a probabilistic density function over the plurality of features based on the preprocessed input data and the domain structure;
apply the PGM to observed or hypothetical evidence in a form of specific values assigned to a subset of features to determine inference results including conditional distribution and maximum a posteriori (MAP) values for one or more variables of interest given evidence;
generate a dependency function between two features represented in the domain structure based on the PGM; and
present an output via a display device based on one or more of the summary statistics, the missingness analysis, the domain structure, the PGM, the inference results, and the dependency function.
